(19) United States
(12) Patent Application Publication
(10) Pub. No.: US 2002/0046273 A1
(43) Pub. Date: Apr. 18, 2002

(54) Method and system for real-time distributed data mining and analysis for network

(76) Inventors: Nils B. Lahr, Antioch Heights, CA (US); Andrew J.H. Jeon, Santa Clara, CA (US)

Correspondence Address: Stacey J. Longanecker, Roylance, Abrams, Berdo & Goodman, L.L.P., Suite 600, 1300 19th Street, N.W., Washington, DC, 20036, US

(21) Appl. No.: 09/770,641

(22) Filed: Jan. 29, 2001

Related U.S. Application Data
(60) Provisional application No. 60/178,753, filed on Jan. 28, 2000.

(51) Int. Cl. G06F 15/16; G06F 15/173

(52) U.S. Cl. 709/224; 709/203

(57) ABSTRACT

A data mining and analysis method and system can be implemented in an open architecture and use a multiple-tiered design to collect and analyze data relating to network devices in essentially real-time or near real-time. Analyzer modules are implemented in a distributed, multi-layered manner and process log data in a distributed and hierarchical manner to reduce data transfer needed for reporting. Analyzer modules analyze sequences of numbers and strings generated from software that understands analyzer module commands such as a parser module for such applications as collecting real-time voting information, and analyzing and aggregating real-time number sequence generated by media servers, among other applications.

This application claims the benefit of U.S. provisional application Ser. No. 60/178,753, filed Jan. 28, 2000.

### CROSS REFERENCE TO RELATED APPLICATIONS

Related subject matter is disclosed in co-pending U.S. patent application of Nils B. Lahr et al., filed Sep. 28, 1998, entitled “Streaming Media Transparency” (attorney's file IBC-P001); in co-pending U.S. patent application of Nils B. Lahr, filed even date herewith, entitled “Method and Apparatus for Encoder-Based Distribution of Live Video and Other Streaming Content” (attorney's file 39512A); in co-pending U.S. patent application of Nils B. Lahr, filed even date herewith, entitled “A System and Method for Rewriting Media Resource Request and/or Response Between Origin Server and Client” (attorney's file 39511A); in co-pending U.S. patent application of Nils B. Lahr, filed even date herewith, entitled “Method and Apparatus for Client-Side Authentication and Stream Selection in a Content Distribution System” (attorney's file 39505A); in co-pending U.S. patent application of Nils B. Lahr, filed even date herewith, entitled “Method and Apparatus for Using Single Uniform Resource Locator for Resources With Multiple Formats” (attorney's file 39502A); in co-pending U.S. patent application of Nils B. Lahr et al., filed even date herewith, entitled “A System and Method for Mirroring and Caching Compressed Data in a Content Distribution System” (attorney's file 39565A); in co-pending U.S. patent application of Nils B. Lahr, filed even date herewith, entitled “A System and Method for Determining Optimal Server in a Distributed Network for Serving Content Streams” (attorney's file 39551A); and in co-pending U.S. patent application of Nils B. Lahr, filed even date herewith, entitled “A System and Method for Performing Broadcast-Enabled Disk Drive Replication in a Distributed Data Delivery Network” (attorney's file 39564A); the entire contents of each of these applications being expressly incorporated herein by reference.

### FIELD OF THE INVENTION

The invention relates to a method and system for essentially real-time, distributed, data mining and analysis data from a plurality of digital video servers or other network devices.

### BACKGROUND OF THE INVENTION

In recent years, the Internet has become a widely used medium for communicating and distributing information. Currently, the Internet can be used to transmit streaming media (e.g., audio and video data) from content providers to end users, such as businesses, small or home offices, and individuals.

As the use of the Internet increases, the Internet is becoming more and more congested. Since the Internet is essentially a network of computers distributed throughout the world, the activity performed by each computer or server to transfer information from a particular source to a particular destination naturally increases in conjunction with increased Internet use. Each computer is generally referred to as a “node” with the transfer of data from one computer or node to another being commonly referred to as a “hop.” Accordingly, due to the huge volume of data that each computer or node is transferring on a daily basis, it is becoming more and more necessary to minimize the amount of hops that are required to transfer data from a source to a particular destination or end user, thus minimizing the amount of computers or nodes needed for a data transfer. Hence, the need exists to distribute servers closer to the end users in terms of the amounts of hops required for the server to reach the end user. Similarly, the need exists to poll information about the network from a plurality of sources in the network in order to use this information to make network load-balancing decisions.

Recently, digital video servers have added the ability to provide information regarding the server in real-time using graphical user interface or GUI-based methods. The types of information which may be provided by the server include server up-time, number of connections, error rates and current clients connected. However, only one digital video server can be visually monitored one at a time and current servers are not equipped to handle a distributed network.

Further, conventional monitoring systems (e.g., located in a main data center that is used to monitor an entire network) are static in that each time information is requested, the request is generated from a centralized resource and then analyzed Moreover, networks that deploy multiple servers do not have precise information regarding what is happening on all of their servers. While servers may conceivably add the ability to monitor via a public application programming interface (API), this is an inefficient method of monitoring in large networks. In particular, monitoring thousands of servers is implemented by polling each individual server which takes an unacceptably long amount of time and does not allow a monitoring system to be scalable. It is also difficult to get granular trending information about the entire network, as this would require the centralized monitoring system to poll all of the information needed to make the trending analysis needed.

Log files are now being used to allow post-event driven analysis in a network. Log files have become an industry standardized method of reporting information such as the number of hits to a web site or logging quality of service information about client connections. These files are generally collected daily, weekly or monthly and then analyzed off-line to mine data. For example, a Windows Media Technology Server logs information about end-user quality experience, but merely collects the data and does not analyze it. Typically, analysts wait several hours or days to gain access to the collected log files from a large network and then aggregate the data for data mining purposes. While the collection and subsequent analysis can be useful, it would be significantly more useful to perform important analysis functions in real-time or near real-time, which existing data mining and analysis methods cannot do. Collection of time-sensitive data using existing methods generally occurs too late for that data to be used effectively.

Network sniffers are available for implementation between a client and a server to analyze the session and report in near real-time about every client. The sniffers analyze sessions and provide statistical data about the service they are monitoring. Sniffers, however, do not analyze log files and therefore cannot provide complete and detailed information about a client session.

In addition, real-time data mining and statistical analysis is difficult for handling by even a single application. Developers typically have to generate new software code each time they desire an application to report statistical information in substantially real-time. This coding is not transferable to another application.

Accordingly, a need exists for a data mining and analysis function that can be implemented in an open architecture (e.g., a multiple-tiered design for network devices) and that allows for essentially real-time or near real-time data mining and analysis for any of the network devices. Further, a need exists for data mining and analysis which abstracts its mathematical and scaling aspects to allow use with a nearly infinitely large network for near real-time reporting.

### SUMMARY OF THE INVENTION

The present invention provides a method and system for obtaining and aggregating information from a distributed system of devices in real-time or near real-time in a manner that does not constantly cause network stress and avoids having to use a centralized monitoring system to poll all of the data needed to provide trending statistics.

In accordance with an aspect of the present invention, real-time digital video aggregate monitoring is provided using a standards-based agent at video servers. Multi-tiered analyzer deployment is provided whereby analyzers are responsible for polling or receiving information from only those devices for which the analyzers are configured to monitor. A query can be answered using information stored in a local database that is populated by a remote analyzer or video server in a near-real time manner.

The present invention is advantageous in that the stress on the network is directly proportional to the detail of the request for information. That is, the more detailed the information that is needed, the more that will be requested from all of the network devices needing to respond. However, if the information is statistical information, this can be gathered from remote statistical software applications that are each responsible for smaller clusters of network devices or, in turn, are responsible for another tier of the statistical applications.

### BRIEF DESCRIPTION OF THE DRAWINGS

These and other objects, advantages and novel features of the invention will be more readily appreciated from the following detail description when read in conjunction with the accompanying drawing, in which:

FIG. 1 is a block diagram illustrating components in a real-time or near real-time, distributed data mining and analysis system constructed in accordance with an embodiment of the present invention;

FIG. 2 illustrates an Internet broadcast system for streaming media constructed in accordance with an embodiment of the present invention;

FIG. 3 is a block diagram of a media serving system constructed in accordance with an embodiment of the present invention;

FIG. 4 is a block diagram of a data center constructed in accordance with an embodiment of the present invention;

FIG. 5 illustrates the data flow of a real-time or near real-time, distributed data mining and analysis system configured in accordance with an embodiment of the present invention to operate in the content distribution system of FIG. 2;

FIGS. 6 and 7 illustrate time synchronization among components in a real-time or near real-time, distributed data mining and analysis system configured in accordance with an embodiment of the present invention; and

FIG. 8 is a block diagram illustrating an example of a network monitoring according to an embodiment of the present invention.

Throughout the drawing figures, like reference numerals will be understood to refer to like parts and components.

### DETAILED DESCRIPTION OF THE PREFERRED EMBODIMENTS OF THE INVENTION

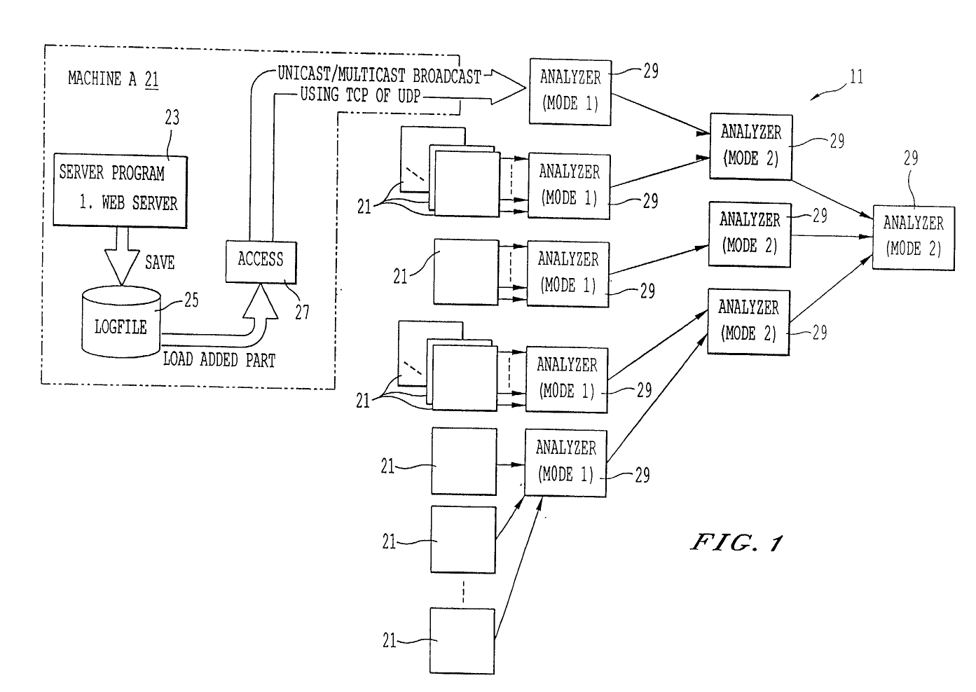

In accordance with the present invention, a real-time or near real-time distributed data mining and analysis system 11 is provided for use in open architecture systems. With reference to FIG. 1, a network device 21 in, for example, a content distribution system generally comprises a server program 23 (e.g., a web server or a media server) that serves data via a network and generates a log file 25 for storage in a local database. As the server 21 serves information to a client, the log file 25 increases. An access module 27 accesses the local database and retrieves preferably only the newly added portion of the log file 25 (e.g., the information added since the last retrieval operation). The retrieved information, that is, a log string is transmitted to the network to a selected analyzer module 29. If the access module 27 uses, for example, Transmission Control Protocol (TCP), then the log string can be unicast to the analyzer 29. Alternatively, the log string can be unicast or broadcast to the analyzer module 29 if User Datagram Protocol (UDP).

The analyzer modules 29 represent software for implementing a state machine for storing and retrieving values for variables. They can be installed in a hierarchical manner to allow information from lower modules or programs 29 to be sent to upper modules 29 to merge the data. Thus, the analyzer modules 29 constitute a distributed, multi-layer analyzing tool which can process log data, for example, in a distributed and hierarchical manner so that the data transfer needed for reporting is significantly reduced to achieve essentially real-time reporting. Real-time reporting is particularly useful for streaming media. Since the analyzer module 29 is designed to work in a distributed fashion, it is highly scalable. The analyzer modules 29 preferably analyze sequences of numbers and strings generated from software that understands analyzer module commands such as a parser module described below. Good uses are, for example, collecting real-time voting information, analyzing and aggregating real-time number sequence generated by media servers, or other specific applications.

Basically, the analyzer module 29 has two different modes. The first mode (i.e., ‘Mode1’) is used to collect and analyze raw source data. As illustrated in FIG. 1, a number of network devices 21 provide source data to respective analyzer modules 29 operating in mode 1. The analyzer modules 29 each store analyzed data in memory in database form (e.g., table, records, and fields). Each analyzer module 29 is operable to manage multiple tables wherein each table may have multiple records and each record may consist of multiple fields. The main differences between a standard database and an analyzer module 29 database are that each record in an analyzer module 29 table can have different fields and each field can have multiple properties or multiple strings.

As indicated in FIG. 1, analyzer modules 29 can be configured to have parent-child relationships whereby one or more Mode1 analyzer modules 29 are child modules instructed to report to a specified parent analyzer module executing in the second mode (i.e., ‘Mode2’). Similarly, a number of Mode2 analyzer modules 29 can be configured as child modules instructed to report to a specified parent Mode2 analyzer module. Thus, Mode2 analyzer modules 29 can collect data from multiple Mode1 analyzer module 29 instances and aggregate data from each connected child. Mode2 analyzer modules 29 can also connect to upper analyzer modules 29 also operating in mode 2 to push data.

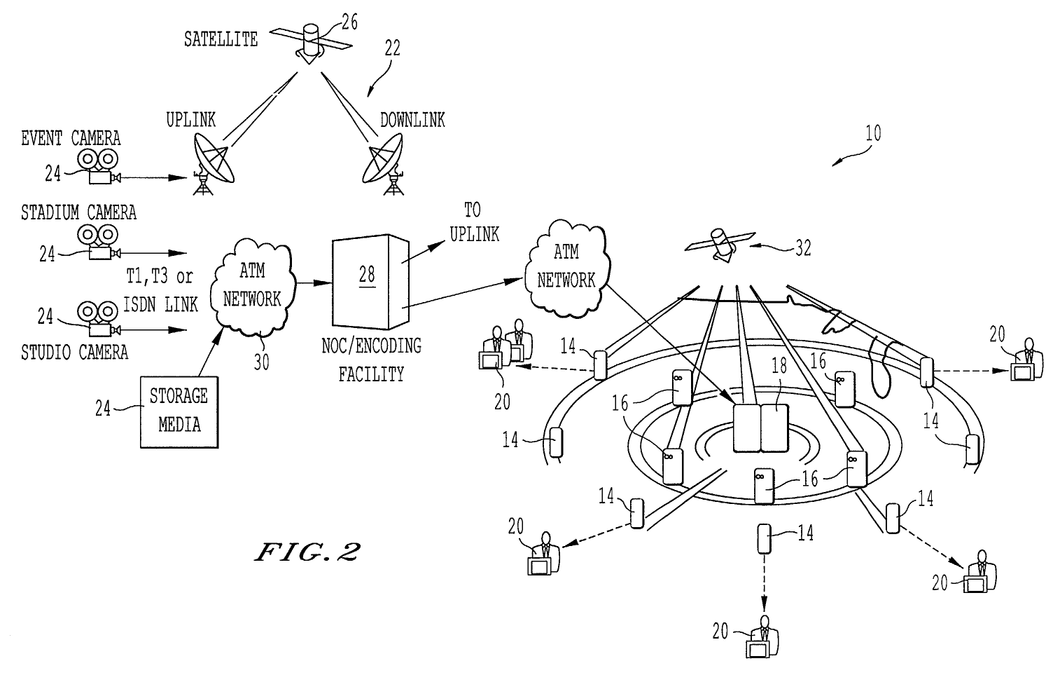

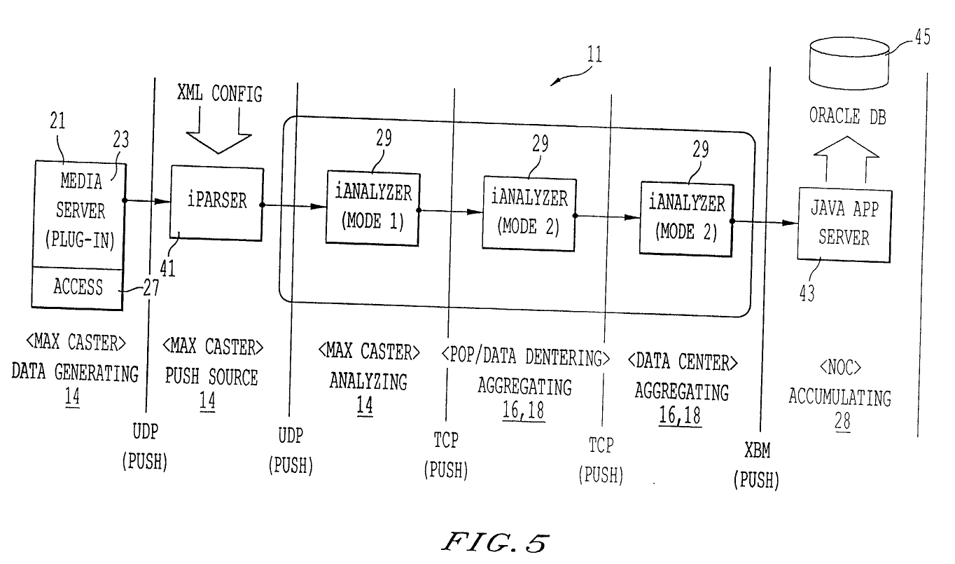

In the following description, an exemplary multi-tiered content distribution system 10 is described in connection with FIGS. 2, 3 and 4 to illustrate the use of the distributed data mining and analysis system 11 and method of the present invention with distributed servers and data centers. It is to be understood, however, that the present invention can be used with essentially any network devices. The data flow of the present invention, as used in an exemplary manner with the content distribution system 10, is illustrated in FIG. 5.

With reference to FIG. 2, a system 10 is provided which captures media (e.g., using a private network), and broadcasts the media (e.g., by satellite) to servers located at the edge of the Internet, that is, where users 20 connect to the Internet such as at a local Internet service provider or ISP. The system 10 bypasses the congestion and expense associated with the Internet backbone to deliver high-fidelity streams at low cost to servers located as close to end users 20 as possible.

To maximize performance, scalability and availability, the system 10 deploys the servers in a tiered hierarchy distribution network indicated generally at 12 that can be built from different numbers and combinations of network building components comprising media serving systems 14, regional data centers 16 and master data centers 18. The system also comprises an acquisition network 22 that is preferably a dedicated network for obtaining media or content for distribution from different sources. The acquisition network 22 can operate as a network operations center (NOC) which manages the content to be distributed, as well as the resources for distributing it. For example, content is preferably dynamically distributed across the system network 12 in response to changing traffic patterns in accordance with the present invention. While only one master data center 18 is illustrated, it is to be understood that the system can employ multiple master data centers, or none at all and simply use regional data centers 16 and media serving systems 14, or only media serving systems 14.

An illustrative acquisition network 22 comprises content sources 24 such as content received from audio and/or video equipment employed at a stadium for a live broadcast via satellite 26. The broadcast signal is provided to an encoding facility 28. Live or simulated live broadcasts can also be rendered via stadium or studio cameras, for example, and transmitted via a terrestrial network such as a T1, T3 or ISDN or other type of a dedicated network 30 that employs asynchronous transfer mode (ATM) or other technology. In addition to live analog or digital signals, the content can include analog tape recordings, and digitally stored information (e.g., media-on-demand or MOD), among other types of content. Further, in addition to a dedicated link 30 or a satellite link 26, the content harvested by the acquisition network 22 can be received via the Internet, other wireless communication links besides a satellite link, or even via shipment of storage media containing the content, among other methods. The encoding facility 28 converts raw content such as digital video into Internet-ready data in different formats such as the Microsoft Windows Media (MWM), RealNetworks G2, or Apple QuickTime (QT) formats. The system 10 also employs unique encoding methods to maximize fidelity of the audio and video signals that are delivered via multicast by the distribution network 12.

With continued reference to FIG. 2, the encoding facility 28 provides encoded data to the hierarchical distribution network 12 via a broadcast backbone which is preferably a point-to-multipoint distribution network. While a satellite link indicated generally at 32 is used, the broadcast backbone employed by the system 10 of the present invention is preferably a hybrid fiber-satellite transmission system that also comprises a terrestrial network 33. The satellite link 32 is preferably dedicated and independent of a satellite link 26 employed for acquisition purposes. The tiered network building components 14, 16 and 18 are each equipped with satellite transceivers to allow the system 10 to simultaneously deliver live streams to all server tiers 14, 16 and 18 and rapidly update on-demand content stored at any tier. When a satellite link 32 is unavailable or impractical, however, the system 10 broadcasts live and on-demand content though fiber links provided in the hierarchical distribution network 12. Where the system 10 pulls the feed from, in the event of a satellite line failure, is based on a set of routing rules that include priorities, weighting, among other factors. The process is similar to that performed by conventional routers, except that it occurs at the actual stream level.

The system 10 employs a director agent to monitor the status of all of the tiers of the distribution network 12 and redirects users 20 to the optimal server, depending on the requested content. The director agent can originate, for example, from the NOC/encoding facility 28. The system employs an Internet Protocol or IP address map to determine where a user 20 is located and then identifies which of the tiered servers 14, 16 and 18 can deliver the highest quality stream, depending on network performance, content location, central processing unit load for each network component, application status, among other factors. Cookies and data from other databases can also be used to facilitate the system intelligence during this process.

Media serving systems 14 comprise hardware and software installed in ISP facilities at the edge of the Internet. The media serving systems preferably only serve users 20 in its subnetwork. Thus, the media serving systems 14 are configured to provide the best media transmission quality possible because the end users 20 are local. A media serving system 14 is similar to an ISP caching server, except that the content served from the media serving system is controlled by the content provider that input the content into the system 10. The media serving systems 14 each serve live streams delivered by the satellite link 32, and store popular content such as current and/or geographically-specific news clips. Each media serving system 14 manages its storage space and deletes content that is less frequently accessed by users 20 in its subnetwork. Content that is not stored at the media serving system 14 can be served from regional data centers.

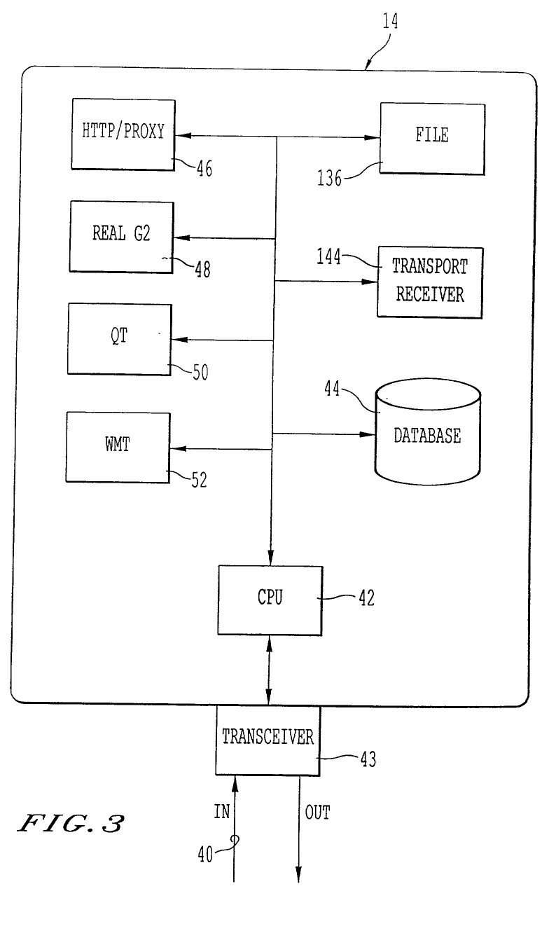

With reference to FIG. 3, a media serving system 14 comprises an input 40 from a satellite and/or terrestrial signal transceiver 43. The media serving system 14 can output content to users 20 in its subnetwork or control/feedback signals for transmission to the NOC or another hierarchical component in the system 10 via a wireline or wireless communication network. The media serving system 14 has a central processing unit 42 and a local storage device 44. A file transport module 136 and a transport receiver 144 are provided to facilitate reception of content from the broadcast backbone. The media serving system 14 also preferably comprises one or more of an HTTP/Proxy server 46, a Real server 48, a QT server 50 and a WMS server 52 to provide content to users 20 in a selected format. The media serving stream can also support caching servers (e.g., Windows and Real caching servers) to allow direct connections to a local box, regardless of whether the content is available. The content is then located in the network 12 and cached locally for playback. Thus, support for split live feeds by a local media serving system is achieved regardless of whether the feed is being sent via a broadcast or otherwise. In other words, pull splits from a media serving system are supported, as well as broadcast streams that are essentially push splits with forward caching.

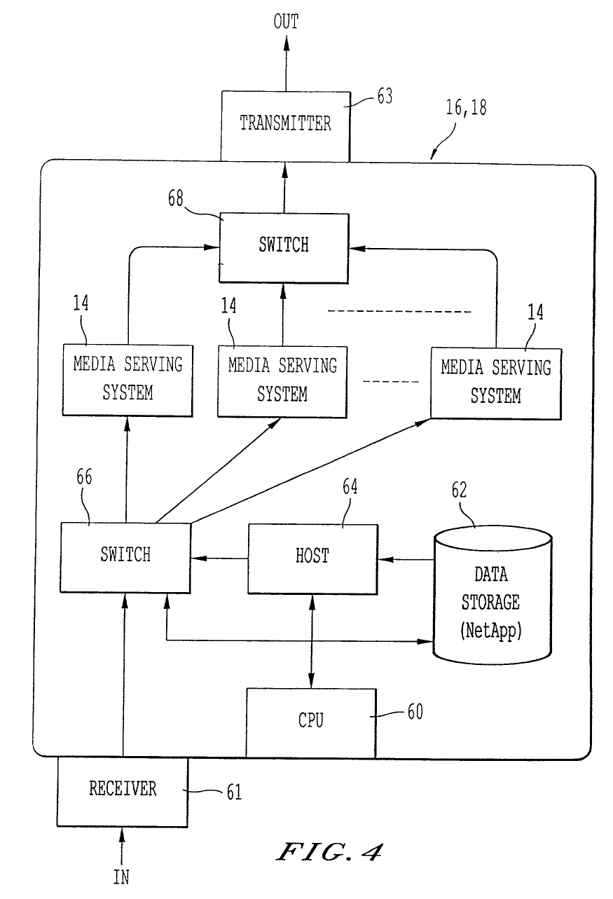

The regional data centers 16 are located at strategic points around the Internet backbone. With reference to FIG. 4, a regional data center 16 comprises a satellite and/or terrestrial signal transceiver, indicated at 61 and 63, to receive inputs and to output content to users 20 or control/feedback signals for transmission to the NOC or another hierarchical component in the system 10 via wireline or wireless communication network. A regional data center 16 preferably has more hardware than a media serving system 14 such as gigabit routers and load-balancing switches 66 and 68, along with high-capacity servers (e.g., plural media serving systems 14) and a storage device 62. The CPU 60 and host 64 are operable to facilitate storage and delivery of less frequently accessed on-demand content using the servers 14 and switches 66 and 68. The regional data centers 16 also deliver content if a standalone media serving system 14 is not available to a particular user 20. The director agent software preferably continuously monitors the status of the standalone media serving systems 14 and reroutes users 20 to the nearest regional data center 16 if the nearest media serving system 14 fails, reaches its fulfillment capacity or drops packets. Users 20 are typically assigned to the regional data center 14 that corresponds with the Internet backbone provider that serves their ISP, thereby maximizing performance of the second tier of the distribution network 12. The regional data centers 14 also serve any users 20 whose ISP does not have an edge server.

The master data centers 18 are similar to regional data centers 16, except that they are preferably much larger hardware deployments and are preferably located in a few peered data centers and co-location facilities, which provide the master data centers with connections to thousands of ISPs. With reference to FIG. 4, master data centers 18 comprises multiterabyte storage systems (e.g., a larger number of media serving systems 14) to manage large libraries of content created, for example, by major media companies. The director agent automatically routes traffic to the closest master data center 18 if a media serving system 14 or regional data center 16 is unavailable. The master data centers 18 can therefore absorb massive surges in demand without impacting the basic operation and reliability of the network.

Transport components are provided in the NOC and/or broadcast facilities, the master data centers 18, the regional data centers 16 and the media serving systems 14 (e.g., file transport module 136, transport receiver 144 and a transport sender) that generalize data input schemes from encoders and optional aggregators in the acquisition system 22 to data senders in the broadcast devices, to generalize data packets within the system 10, and to generalize data feeding from data receivers in media servers to other components to support essentially any media format. The transport components preferably employ RTP as a packet format and XML-based remote procedure calls (XBM) to communicate.

With reference to FIG. 5, the data flow of the distributed data mining and analysis system 11 of the present invention will now be described in the context of the content distribution system 10 for illustrative purposes. FIG. 5 depicts a real-time log-reporting application of the analyzer modules 29. A data generating device in the data mining and analysis system 11 can be a media server (e.g., a plug-in in the media serving system 14 in FIG. 2). A parser module 41 and a Java XBM App server 43 are provided, respectively, as an input and final data processing application. The analyzer modules 29 are used as dynamic log analyzing and aggregating tools and are deployed at one of the tiered devices 14, 16 and 18 or in the acquisition network 22 in the content distribution system 10.

The parser module 41 is a tool that receives a log line generated by a media server 21 and parses its fields and field values. The access module 23 operates in conjunction with the media server 21 to provide packets to the parser module 41 when events occur such as the beginning or end of a stream. When the access module sends a log line to the parser module 41, it adds information into the header to assist the parser module 41 with the identification of the type media server generating the log line. The parser module 41 has its own XML-based log definition file that describes which portion of log should be used as a analyzer module field and how to create a table and record of the analyzer module 29. The parser module 41 then sends a command to an analyzer module 29 to register a new variable and also sets a field value to each field. The parser module 41 is preferably the driver of the entire network 11 for creating and updating tables.

The analyzer modules 29 are generic statistics-analyzing tools. An analyzer module 29 gets commands from the parser module 41 and analyzes each field of a command based on the analyzing method of each field. Once the specified interval has elapsed, tables created in an analyzer module executing in Mode1 are transmitted to the root tier analyzer module 29.

The root tier of analyzer module 29 pushes tables into the Java App server 43 using an XBM function call. The tables are then sent to be stored in a database 45 (e.g., an Oracle database) by the Java App server 43.

As stated previously, the media server plug-in 21 generates source information and sends it to the parser module 41 (e.g., using UDP). The parser module 41 parses each log line sent from different media server plug-ins (e.g., WMT server 52, Real G2 server 48, and the like) and generates commands using a configuration file for each media server type. The parser module 41 preferably uses an XML-based log definition file for processing each line. The XML-based log definition file describes how a log file 25 is organized, which field is to be processed, and how the field is to be processed. The parser module 41 determines which variables are to be stored in the analyzer module 29 and sets the variables with appropriate values by sending commands to the analyzer module 29. The communication between the plug-ins 21 and the parser module 41, and between the parser module 41 and the analyzer module 29 is preferably UDP.

For illustrative purposes, the following information is preferably maintained for each content provider (i.e., account) in the content distribution system 10:

TABLE 1
Real-Time Monitored Data

| | Current | Peak |
|---|---|---|
| MOD | | |
| WMT | 564 | 654 |
| Real | 215 | 300 |
| Total | 779 | 954 |
| On-Air | | |
| WMT | 564 | 654 |
| Real | 115 | 200 |
| Total | 679 | 854 |
| On-Stage | | |
| WMT | 564 | 654 |
| Real | 215 | 300 |
| Total | 779 | 954 |

Thus, for each content provider, the concurrent stream numbers are divided into different combinations of products (e.g., on-demand service, on-air service for continuous streaming for radio stations, news feeds, and the like, and on-stage service for event webcasts) and formats (e.g., Netshow, Real and QuickTime). For each content provider, the concurrent stream number is divided into the following categories:

| | |
|---|---|
| dmd-ns | (OnDemand Netshow) |
| dmd-g2 | (OnDemand Real) |
| dmd-qt | (OnDemand QuickTime) |
| stg-ns | (OnStage Netshow) |
| stg-g2 | (OnStage Real) |
| stg-qt | (OnStage QuickTime) |
| air-ns | (OnAir Netshow) |
| air-g2 | (OnAir Real) |
| air-qt | (OnAir QuickTime) |

The current connection number and peak values for each product and format combination are stored for the sampling duration of 5 minutes, for example. The lowest layer analyzer modules 29 therefore monitor the connection numbers for 5 minutes and send the sampled data to upper layer analyzer modules 29. These analyzer modules 29, in turn, collect information from the lower layer analyzer modules 29 and send the merged data to higher level analyzer modules 29.

In order for the parser module 41 to divide the concurrent stream into different product-format types and send the right commands to the analyzer module 29, the parser module preferably extracts the following parameters whenever it receives a log packet:

| | |
|---|---|
| account | (content provider name such as CNN, ABC etc.) |
| product | (OnDemand, OnStage, OnAir) |
| format | (media type such as Netshow, Real) |
| asset | (media file name including the) |
| starttime | (starting time of the stream) |
| endtime | (ending time of the stream) |

TABLE 2
Sample URLs in the log packets

| | Sample URL in the log |
|---|---|
| Dmd-ns | mms://10.0.3.40/cnn/1.asf |
| Air-ns | mms://10.0.3.40/v2/onair/cnn/2.asf |
| Stg-ns | mms://10.0.3.40/v2/onstage/cnn/3.asf |
| Dmd-g2 | cnn/dir1/1.asf |
| Air-g2 | ibeam/v2/onair/cnn/2.asf |
| Stg-g2 | ibeam/v2/onstage/cnn/3.asf |
| Dmd-qt | rtsp://10.0.3.40/cnn/1.asf |
| Air-g2 | rtsp://10.0.3.40/v2/onair/cnn/2.asf |
| Stg-g2 | rtsp://10.0.3.40/v2/onstage/cnn/3.asf |

The URL of a stream that is being served is provided in a log packet. Since the format of the URL is not consistent for each product and media format types, multiple instruction sets are defined to extract the required parameters (account, product, and so on). These instructions are defined in the configuration file to facilitate future expandability. The parser module 41 configuration file and how these parameters are extracted by using the configuration file setup will now be described.

When the parser module 41 receives a log packet, it extracts appropriate parameters from the packet (e.g., account, product, format, startime, endtime and asset). If the packet is from a content provider that parser module has not processed before, it registers the required variables to the analyzer module 29. For example, these variables can be presented in product-format form and defined in the <RegVarList> section in the configuration file. Whenever a stream is started, the parser module 41 sends a command to increase an appropriate field for the given content provider. When a stream is stopped, the parser module 41 sends a command to decrease the field by one for the content provider.

As stated previously, the parser module configuration file is preferably an XML file that is used to setup the default parameters and information required to parse the log packets given to the parser module. The configuration file comprises the following six sections:

1. GlobalSetting

2. ProductList

3. FormatList

4. GeneratorIdList

5. StaticVarList

6. RegisterVarList

7. InstructionsList

In the GlobalSetting section, the local Internet Protocol (IP) address and port are used by the parser module to listen for the log packets that are sent by the log packet generator programs such as the media server plug-ins. Destination IP address and port are the address of an analyzer module 29 to which the parser module will send the data. Whenever the parser module sends a command to the analyzer module, it determines when the content provider was last registered to the analyzer module. If it passed more than RegisterInterval seconds, it will re-register the content provider to analyzer module.

All of the programs that send the log packets to the parser module preferably have Generator IDs. The parser module can identify which program actually sent a packet by looking at the Generator ID attached at the log packet. In the configuration file, possible Generator IDs are listed. For example, for the NetShow plug-in, it is “NSPlugIn”; for Real, it is “G2PlugIn” and for QuickTime, it is “QTPlugIn”.

Each stream served from a network server 14, 16 or 18 can be categorized as products to content providers, as indicated by the Product List. The products can be: “OnDemand”, “OnAir” and “OnStage”. Streams can also be categorized as stream media types as referenced in the Format List.

Variables that are registered to an analyzer module for each account (e.g., content provider) are listed in the RegisterVarList lists. For each variable, table, field, type and method attributes are specified. For each log packet, certain parameters (such as format, product etc.) have to be extracted. In the StaticVarList section of the configuration file, some of the parameters can be set statically, depending on the Generator Id. Thus, if the packet is sent from the program with the generator, specified static variable is used.

Due to the variety of URL formats, it is necessary to define multiple instruction sets to extract the parameter values (product, account, startime, endtime, and so on) depending on the format of the URL using the InstructionsList. The following is an exemplary logic parser module to use to decide which instruction set to use:

1. if GeneratorID=“g2plugin” && URL does not contains “/v2/on”, it is OnDemand for Real. Use first instruction set.

2. URL does not contains “/v2/on”, it is OnDemand for Netshow and QT. Use instruction set 2.

3. if GeneratorID=“nsplugin” && URL contains “/v2/onair”, it is OnAir for Netshow. Use instruction set 3.

4. if GeneratorID=“nsplugin” && URL contains “/v2/onstage”, it is OnStage for Netshow. Use instruction set 4.

5. if GeneratorBD=“qtplugin” && URL contains “/v2/onair”, it is OnAir for QuickTime. Use instruction set 5.

6. if GeneratorID=“qtplugin” && URL contains “/v2/onstage”, it is OnStage for QuickTime. Use instruction set 6.

7. if GeneratorID=“g2plugin” && URL contains “/v2/onair”, it is OnAir for Real. Use instruction set 5.

8. if GeneratorID=“g2plugin” && URL contains “/v2/onstage”, it is OnStage for Real. Use instruction set 6.

In order to define these conditional selections of instruction sets and conserve the future expandability, instruction sets are defined as follows:

<InstructionsList>

<Instructions NotContain=”aaa” Contain=”bbb”
GeneratorId=”bbb”>

<Item . . .
<Item . . .

</Instructions>
<Instructions NotContain=”ddd” Contain=”eee”
GeneratorId=”fff”>

<Item . . .
<Item . . .

</Instructions>
. . .

</InstructionList>

In the instructions list, many instruction sets can be defined. When a log is to be parsed, the instruction set is considered from the first one until the matching one is found. For each instruction set, it can have three kinds of attributes: NotContain, Contain, GeneratorId. They attributes can be used by themselves or in combination. The NotContain attribute indicates that, if the log does not contain the specified substring, the instruction set is used. The Contain attribute indicates that if the log contains the specified substring, the instruction set is used. The GeneratorId attribute indicates that if the generator id is matched, then the instruction set is used.

The analyzer module 29 can handle Number and String data types. In case of Number, analyzer module processes a ‘Null-Terminated’ string as a string type representation of an integer. Therefore, it will be converted to ‘int’ type using ‘atoi()’ function. In the cease of String, analyzer module regards handed ‘Null-terminated’ strings as C language's standard ‘Null-Terminated’ string representing some variable. The analyzer module keeps monitoring for data sent from other applications. It could be a sequence of numbers (e.g., 10, 15, 21, . . . ) or a sequence of strings (e.g., Tomato, Apple, Orange, Apple . . . ) related to each field type.

For Number type data, handed strings are converted into C language type “int” to allow essentially any arithmetic operation to be performed with them. An analyzer module 29 has the ability to get several values from these number sequences, as shown in Table 3.

TABLE 3
Values for Number Sequences

| Method | Meaning |
|---|---|
| Average | Average of total number sequence |
| Biggest Number | Biggest number out of entire sequence of numbers |
| Smallest Number | Smallest number out of entire sequence of |
| | numbers |
| Total | Total sum of who sequence of numbers |
| Average of Total | Average to total values |
| Biggest Total Number | Biggest number out of sequenced total value |
| Smallest Total Number | Smallest number out of sequenced total number |

A number analyzing example is shown in Table 4:

TABLE 4
Number Analyzing Sample

| | Number | | | | | Total | Total | Total |
|---|---|---|---|---|---|---|---|---|
| # Seq | Sent | Average | Biggest | Smallest | Total | Average | Biggest | Smallest |
| 1 | 10 | 10 | 10 | 10 | 10 | 10 | 10 | 10 |
| 2 | 20 | 15 | 20 | 10 | 30 | 20 | 30 | 10 |
| 3 | 10 | 13.33 | 20 | 10 | 40 | 26.66 | 40 | 10 |
| 4 | 5 | 11.24 | 20 | 5 | 45 | 31.24 | 45 | 10 |
| 5 | 22 | 13/39 | 22 | 5 | 67 | 38.39 | 67 | 10 |
| 6 | 32 | 16.49 | 32 | 5 | 99 | 48.49 | 99 | 10 |

Once a user registers a number type field into an analyzer module 29, the analyzer module creates a instance of class that manipulates Number type fields. Whenever a new number is sent to analyzer module, it updates its statistical analysis result.

For Seq. #4 in the number analyzing example above, consider when the fourth number is sent to the analyzer module. The previous average value was ‘13.33’. At this point, analyzer module gets the new average value using the formula below:

$$\begin{matrix}NewAve = \frac{previous Ave \times Count of number sent + current number sent}{Count Of Number Sent + 1} \\ = \frac{( 13.33 \times 3 ) + 5}{4} = 11.24\end{matrix}$$

‘Total Average’ uses the same formula, but the input value is the new ‘total’ value and the ‘previous total average’.

An analyzer module supports ‘Total Biggest’, ‘Total Smallest’ and ‘Total Average’ even though the ‘Total Biggest’ value is always equal to ‘Total’ value. The next example illustrates the use of these values.

Table 5 below shows that, if the sequence of numbers represents the changed Delta of some amount, ‘Total Biggest’ represents the peak value of ‘Total’ sum, and ‘Total Average’ has a similar meaning to ‘Average’ value of previous table.

TABLE 5
Delta Values for Table 4

| | Number | | | | | Total | Total | Total |
|---|---|---|---|---|---|---|---|---|
| # Seq | Sent | Average | Biggest | Smallest | Total | Average | Biggest | Smallest |
| 1 | 1 | 1 | 1 | −1 | 1 | 1 | 1 | 1 |
| 2 | 1 | 1 | 1 | −1 | 2 | 1.5 | 2 | 1 |
| 3 | −1 | 0.66 | 1 | −1 | 1 | 1.33 | 2 | 1 |
| 4 | 1 | 0.75 | 1 | −1 | 2 | 1.49 | 2 | 1 |
| 5 | 1 | 0.8 | 1 | −1 | 3 | 1.79 | 3 | 1 |
| 6 | −1 | 0.66 | 1 | −1 | 2 | 1.82 | 3 | 1 |

No matter whether real numbers or changed Delta of numbers are sent to the analyzer module, the user needs to choose the kind of statistical report desired. In Table 4 or example, ‘Total Biggest’ and ‘Total Smallest’ have no useful meaning, and for Table 5, ‘Average’, ‘Biggest’, ‘Smallest’ have no useful meaning.

The analyzer module also supports functionality to analyze String type variables.

TABLE 6
String Analyzing Example

| | String | |
|---|---|---|
| | Sent to | |
| # | analyzer | Statistical information maintained |
| Seq | module | in analyzer module |
| 1 | Tomato | Tomato: 100%(1) |
| 2 | Banana | Tomato: 50%(1), Banana: 50%(1) |
| 3 | Lemon | Tomato: 33.33%(1), Banana: 33.33%(1), |
| | | Lemon: 33.33%(1) |
| 4 | Banana | Tomato: 25%(1), Banana: 50%(2), Lemon: 25%(1) |
| 5 | Tomato | Tomato: 40%(2), Banana: 40%(2), Lemon: 20%(1) |
| 6 | Banana | Tomato: 33.33%(2), Banana: 50%(3), |
| | | lemon: 16.66%(1) |
| 7 | Tomato | Tomato: 42.85%(3), Banana: 42.85%(3), |
| | | Lemon: 14.28%(1) |
| 8 | Lemon | Tomato: 37.5%(3), Banana: 37.5%(3), |
| | | Lemon: 12.5%(2) |
| 9 | Lemon | Tomato: 33.33%(3), Banana: 33.33%(3), |
| | | Lemon: 33.33%(3) |

From Sequence #1 to #3, to the analyzer module point of view, a new string appears. When the new string is sent, the analyzer module 29 allocates enough memory to store that string and keep track of hit counts for each string. Once a string is added, whenever the same string is received, the analyzer module simply adds to the hit count and recalculates the statistics.

The String type is useful for frequencies of string variables. For example, when there is voting, the data collection program can merely send each candidate's name to an analyzer module and the analyzer module automatically tallies the voting result.

Once data is analyzed in an instance of analyzer module Mode 1, the data of that analyzer module Mode1 can be aggregated into an analyzer module running in Mode 2. This concept is generically implemented so that users can set any topology between multiple analyzer modules in Mode1 and Mode2.

FIG. 1 above shows that multiple Mode 1 instances can be connected to a Mode 2 instance, and that a Mode 2 instance can send aggregated data to an upper level Mode2 instance. The analyzer module 29 uses formulas to aggregate field types. Assuming each analyzer module mode1 instance in FIG. 1 has one number type and one string type variable, and each sends its information to analyzer module mode2, an analyzer module in Mode 2 collects data from different analyzer module Mode1 instances. How the analyzer module Mode2 aggregates multiple fields with data types Number and String will now be described.

The analyzer module uses its own formula to aggregate multiple number type fields. The table below demonstrates how analyzer module Mode2 does this. Once an analyzer module starts aggregating, it copies the first field to its memory table, and adds each field instance thereafter.

The method of addition for each field's method property is not always the same. For example, in the case of ‘Average’, a total hit count for each average value is needed in order to add them. Assuming a two-field instance, A and B, and the hit count for each record is hA, hB, the average for each field is aA, aB. The formula to get the average is shown below.

$$Weighted Average = \frac{( HA \times aA ) + ( hB \times aB )}{hA = hB}$$

The algorithm used to get the aggregated ‘Biggest” and “Smallest’ values is relatively simple. “Biggest” is the bigger value of field A's ‘biggest’ and field b's “biggest”, and ‘smallest’ is the smaller value. The ‘Total’, ‘Total Average”, ‘Total Biggest’, and ‘Total Smallest’ values, however, are obtained from adding field A's value to field B's value.

TABLE 7
Number Field Aggregating Simulation

| Push | Hit | | | | | Total | Total | Total |
|---|---|---|---|---|---|---|---|---|
| # Seq | Count | Average | Biggest | Smallest | Total | Average | Biggest | Smallest |
| 1) | 5 | 8 | 10 | 5 | 40 | 22 | 38 | 2 |
| Result | 5 | 8 | 10 | 5 | 40 | 22 | 38 | 2 |
| 2) | 10 | 6.5 | 12 | 3 | 65 | 32 | 72 | 6 |
| Result | 15 | 7 | 12 | 3 | 105 | 54 | 110 | 8 |
| 3) | 20 | 3 | 9 | 2 | 60 | 30 | 40 | 8 |
| Result | 35 | 4.71 | 12 | 2 | 165 | 84 | 150 | 16 |

Table 7 above shows how an analyzer module applies number field aggregating rules. When pushed data arrives from an analyzer module in Mode1 (1), an analyzer module in Mode 2 copies all fields into its database. After receiving data from connection (2), it adds those fields with the fields from (1). The row corresponding to Hit Count 15 of Table 7 is a good example to test the aggregating formula Average value ‘7’ is a result of following formula:

$$Weighted Average = \frac{( hA \times aA ) + ( hB \times aB )}{hA = Hb} = \frac{( 5 \times 8 ) + ( 10 \times 6.5 )}{5 + 10} = 7$$

But ‘total average” is obtained from adding 22 with 32, not from averaging 22 and 32. In conclusion, no matter how many Mode1 analyzer modules are connected to the analyzer module in Mode 2, field size never changes, because fields sent from the Mode1 analyzer modules are compressed into a single field.

For String type data, the same method is used to aggregate multiple fields. If a new string appears, that string is added and the statistics recalculated for each string.

TABLE 8
String Field Aggregating Simulation

| Push | |
|---|---|
| Seq # | String Field Sent to analyzer module |
| 1 | Tomato: 50%(2), Banana: 50%(2) |
| Result | Tomato: 50%(2), Banana: 50%(2) |
| 2 | Tomato: 27.27%(3), Banana 27.27%(3), Lemon 45.45%(5) |
| Result | Tomato: 50%(5), Banana: 50%(5), Lemon: 33%(5) |
| 3 | Lemon: 40%(10), Apple: 40%(10), Pineapple: 20%(5) |
| Result | Tomato: 12.5%(5) Banana: 12.5%(5) lemon: 37.5%(15) |
| | Apple: 25%(10) Pineapple: 12.5%(5) |

After receiving #1 instance, the analyzer module 29 copies it into its memory. When it receives #2 instance, it adds to the hit count, if the string is the same. If there is a new string, it adds that string and copies its hit count. Regarding the second result: ‘Tomato’ and ‘Banana’ were already in analyzer module Mode2’ memory, so it just adds the hit count (5=2=3). ‘Lemon’ was not, however, so ‘Lemon’ is added and the hit count set to ‘5’.

Field manipulation methods have been discussed in the past sections, but usually handling of multiple fields and even multiple tables is needed. An analyzer module 29 has functions to manage multiple tables similar to those of a database management system like Oracle. The database concept that an analyzer module uses is simpler than other database software, but well suited for its purposes.

Note in Table 9 below that the structure of each record in a table may be different, and that every record has its own name to distinguish it from others. In database management, “Name of Record’ has a equal meaning to ‘Primary Key’ in a table. ‘Apple’, ‘Banana’ and ‘Mango’ in a ‘Fruits’ table is used as a primary key. If the string fields are considered, one field has a multiple string value in it. This is a significant difference between the string field in a typical database system and that of analyzer module.

TABLE 9
Example Fields in a Table

| Table | | | |
|---|---|---|---|
| Name | Records | Fields | Fields Value |
| Fruits | Apple | Count (Num) | 25 |
| | | Color (String) | “Red”: 40%(10), “Green”: 60%(15) |
| | | Weight (Num) | 208 |
| | Banana | Length (Num) | 230 |
| | | Count (Num) | 12 |
| | Mango | Count (Num) | 20 |
| | | Origin (String) | “Mexico”: 55%(11), “Hawaii”: 45%(9) |
| Cars | Porsche | Count (Num) | 8 |
| | | Model (String) | “911”: 12.5%(1), “928”: 87.5%(7) |
| | BMW | Count (Num) | 12 |
| | | Model (String) | “325I”: 33%,(4), “525”: 33%, “740I”: |
| | | | 33%(4) |

In the case of database software, SQL (Structured Query Language) is generally used to create, update, and select a table. An analyzer module is preferably a lightweight analyzing tool and therefore it uses its own language. It is relatively simple and ease to use. Commands to manipulate analyzer module databases are discussed in this section. The list of possible commands is shown below.

TABLE 10
Command List

| Command | Description | Abbreviation |
|---|---|---|
| Register | Register a new table/record/field | Reg |
| SetField | Set a field with new value | Set |
| Reset Field | Reset a data of specified field | Rsf |
| SetRecord | Set a record with as many data as its | Rec |
| | fields | |
| ResetRecord | Reset a record (empty whole record) | Rsr |
| GetTables | Get the list of table names | Gtb |
| RetTables | Return a table's name (Unique ID) | Rtb |
| GetRecords | Get the list of records | Grc |
| RetRecords | Return a record's name (Unique ID) | Rrc |
| GetFields | Get the list of fields | Gfl |
| RetFields | Return a field's data in BLOB form | Rrfl |
| Delete | Delete a field/record/table | Del |
| GetTimeTag | Get time tag from connected peer | Gtt |
| RetTimeTag | Return a time tag to requester | Rtt |
| Disconnect | Disconnect connection | Bye |

Table 10 lists all commands that are preferably used in an analyzer module 29. Some of these commands are only used between raw data input software, and others are used between analyzer modules in mode2 and analyzer modules in mode1, or between analyzer modules implementing mode 2 instances. The commands that are usually generated by bottom tier applications and sent to analyzer modules in Mode1 are ‘Register’ and ‘SetField’ ‘SetRecord’, ‘ResetRecord’, and ‘Delete’. Generally, only ‘Register’ and ‘SetField’ are used as core input commands. The others are used between analyzer modules; therefore an end user of analyzer module may have no chance to use those commands directly. The commands will now be discussed.

The ‘Register’ command is used to register a new field. If the table/record doesn't exist, analyzer module creates and adds a new table/record with the specified name first, and then adds the field. If the field already exists, the command is ignored.

Register{Table Name}{Record ID}{Field Name}{Field Type}|[Method]}

Field Types: {“num”51 “str”}

Available field types are ‘num’ and ‘str’ as a null-terminated string. If ‘num’ is specified, the number field is added, and for ‘str’, a string field is added.

Field Methods

There is no field method available for String, only Number. A list of methods for number fields is shown below.

TABLE 11
Number Field Methods

| Method | Description |
|---|---|
| Ave | Flag specifies whether to get the average of numbers |
| Biggest | Flag specifies whether to get the biggest number |
| Smallest | Flag specifies whether to get smallest number |
| Total | Flag specifies whether to get total value of numbers |
| TotAve | Flag specifies whether to get total average of total |
| | numbers |
| TotBiggest | Flag specifies whether to get the biggest total number |
| TotSmallest | Flag specifies whether to get the smallest total number |
| EAve | An ‘E’ added to the front of any flag above means that |
| | flag value expires after one set time interval elapses. |
| EBiggest | |
| ESmallest | For example, if the time interval for expiration is |
| | 5 minutes, and if a field is registered with following |
| | command, only the total value will be reset |
| ETotal | every 5 minutes (etotal'). |
| ETotAve | “Register table1 record1myfield num ave+total+biggest+ |
| | etotal” |
| EtotBiggest | |
| | Note: The entire command string is case-insensitive |
| ETotSmallest | |

For example, Register summary Cnn mod-wmt number total+totbiggest

The ‘SetField’ command is used to set a field value. Whenever a field value is set, related information, such as average, biggest, total, etc., are recalculated based on the new field value. If the specified table name or record with ‘Record ID’ or field with ‘Field Name’ is not found, the command is ignored. If the command has no error and the appropriate field is found, the analyzer module 29 converts a null-terminated string ‘value’ into the proper format. In the case of a Number format, the string is converted into an integer and in the case of a String field, the value is used as is.

SetField{Table Name}{Record ID}{Field Name}{Value}

For example:

SetField summary cnn mod-wmt 31

If the field ‘mod-wmt’ is number type field, string “31” is converted into integer 31

The ‘ResetField’ command is used to reset the fields of all records in a table. If a table has 20 records, and each record has a field named ‘mod-wmt,’ that field of those 20 records is reset with ‘0’. But if [Method] is set with field method such as ‘average’, ‘total’, ‘totbiggest’, the analyzer module resets only those field methods.

ResetField{Table Name}{Field Name}[Method]

For example:

Resetfield summary mod-wmt

Resetfield summary onAir-wmt

Resetfield summary onAir-wmt total

Resetfield summary onAir-wmt total+totbiggest+average=>reset 3 property of ‘onAir-wmt’ field.

Sometimes, a user might want to set multiple fields at one time instead of sending the ‘Setfield’ command as many times as there are fields. The user can use the SetRecord command to set the value of multiple fields at one time.

SetRecord{Table Name}{Record ID]{[value]|[value]|. . . }

For example:

Assume 4 fields in the ‘cnn’ record of ‘summary’ table

SetRecord Summary cnn 10 21→only 2 fields are set

SetRecord Summary cnn 11 12 14 60→all 4 fields are set

SetRecord Summary cnn 33 41 23 64 64 21 12→21, 12 ignored

The ‘Reset Record’ command is used to reset a whole record. If there are three fields, all three fields are deleted.

ResetRecord{Table Name}{Record ID}

For example:

ResetRecord Summary cnn

ResetRecord Summary abc

The Delete command is used to delete the table, record and/or field specified.

Delete{{Table Name}|[Record ID]|[Field Name]}

For example:

Delete Summary cnn mod-wmt→delete only field named ‘mod-wmt’

Delete Summary cnn→delete whole record named ‘cnn’

Delete Summary→delete entire table named ‘summary’

The ‘GetTables’ and ‘RetTables’ commands usually occur together. Usually, an upper level analyzer module sends the ‘GetTables’ command to its child node and the child node responds with the ‘RetTable’ command. Multiple ‘RetTables’ commands can return for a single ‘GetTable’ command, because ‘RetTables’ commands should be sent for each table. If there are three tables, commands sent between parent and child would appear as follows:

Get Tables and RetTables{Count}{Current}{Table Name}

For example:

GetTables→from Parent node to Child

RetTables 3 0 table1→from Child to Parent (wait for 2 more)

RetTables 3 1 table2→from Child to Parent (wait for 1 more)

RetTables 3 2 table3→from Child to Parent (stops waiting)

If the first ‘RetTables’ call contains the total number ‘3’, the parent node would wait for two more ‘RetTables’ command calls.

The mechanism of the ‘GetRecords’ and ‘RetRecords’ commands is identical to the ‘GetTables and RetTables’ command call. The only difference is that the ‘GetRecords’ command requires the name of table. Generally, the ‘GetRecords’ call is sent from the parent to the child node when the ‘GetTables” call is finished.

GetRecords{Table Name}and RetRecords{Count}{Current}{Records Name}

For example:

GetRecords summary→from Parent node to Child

ReRecords 3 0 table1→from Child to Parent (wait for 2 more)

RetRecords 3 1 table2→from Child to Parent (wait for 1 more)

RetRecords 3 2 table3→from Child to Parent (stops waiting)

The ‘GetFields’ command uses the same mechanism as ‘GetTable’ and ‘GetRecords’ and requires ‘Table Name’ and ‘Record ID’ to get all the fields. When the child node returns the field data, it uses BLOB (Binary Large OBject) format to save network bandwidth. ‘\x0d\x0a’ is used to determine the starting point of BLOB data.

GetFields{Table Name}{Record ID}⇄RetFields{Count}{Current}{Field Name}{BLOB Ien}{“\x0d\x0a”}{BLOB}

For example:

GetFields Summary Cnn

RetFields 2 0 mod-wmt 10\x0d\x0a\x01af034f1f54a0082c3e

RetFields 2 1 onAir-wmt \x0d\x0d\x0a\x4f1f54a0082c3e01af03

GetTimeTag is used by upper level lAnalyzers to get the current time tag of connected child analyzer modules. The concept of ‘time tag’ is explained in the next section. Parent analyzer module nodes send ‘GetTimeTag’ commands to child nodes and the child nodes send back the ‘RetTimeTag’ with their current timetag value.

GetTimeTag⇄RetTimeTag{TimeTag}

Whenever data transmission is finished, the analyzer module 29 sends a ‘Disconnect’ command to its peer. In the case of a child node, it sends this command when the next push request is issued, while the previous push job is ongoing. This means the child node asks its parent node to gracefully disconnect. In case of a parent node, when the parent receives all the data from the child node, it sends a disconnect message to notify the child that data pushing has finished, and the child then disconnects.

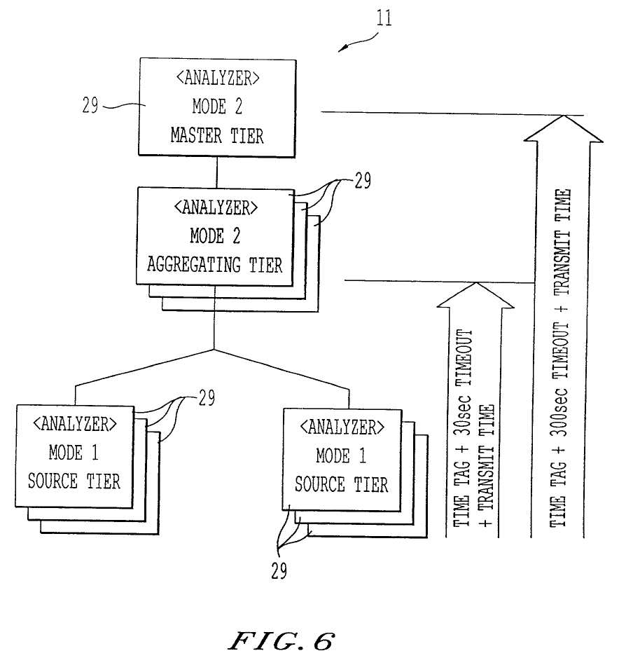

FIG. 6 depicts the hierarchy from the bottom (source) tier to top (master) tier. The machine(s) executing analyzer module(s) 29 are preferably time-synched based on UTC time.

‘Time Tag’ is an integer representing a certain interval within a day from midnight. For example, if the time interval used by analyzer module is 5 minutes, the mammal number of ‘Time Tag’ is 24 hours×60 minutes=284 (available numbers range from 0˜283). Therefore, if the time tag is 2, that refers to data generated between 12:10:00a.m˜12:14:59. If analyzer module uses a time string directly, it consumes more bandwidth. Using Time Tags, it is possible for analyzer module to aggregate data generated at the same time and save bandwidth.

The absolute timeout time for each analyzer module Mode2 instance (Aggregating/Master Tier) is calculated based on the timetag (calculated from Interval). If the interval is 5 minutes, the current time tag received from analyzer module Mod1 is ‘5’, and the timeout for the aggregating tier and master tier is 30 and 300 seconds, the absolute timeout for each tier is as follows:

| | | |
|---|---|---|
| Source: | Time Tag is 5 | = 12:25:00 am |
| Aggregatier Tie: | Timeout is 30 = Time Tag + 30 sec | = 12:25:30 am |
| Master Tier : | Timeout is 300 = TimeTag + 30 sec | = 12:30:00 am |

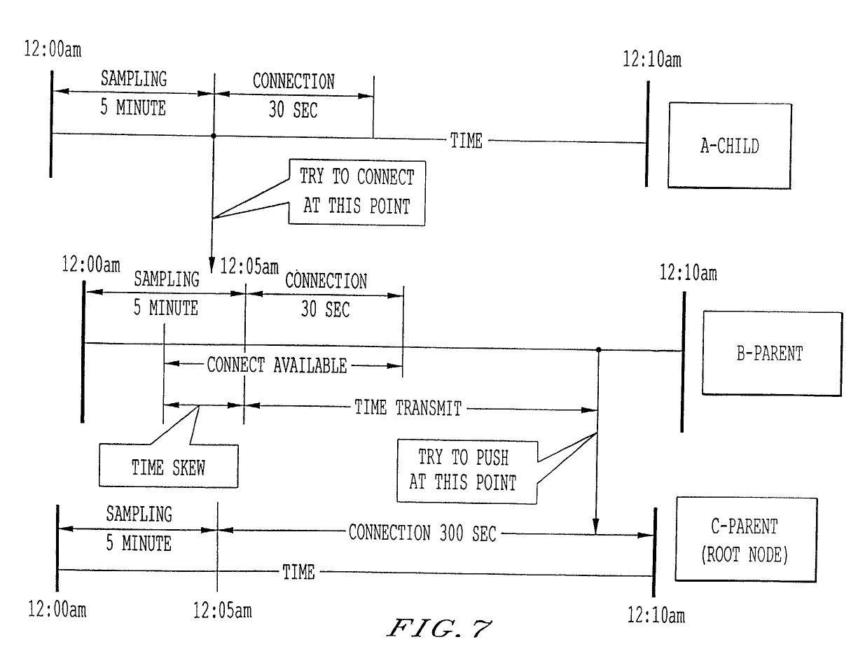

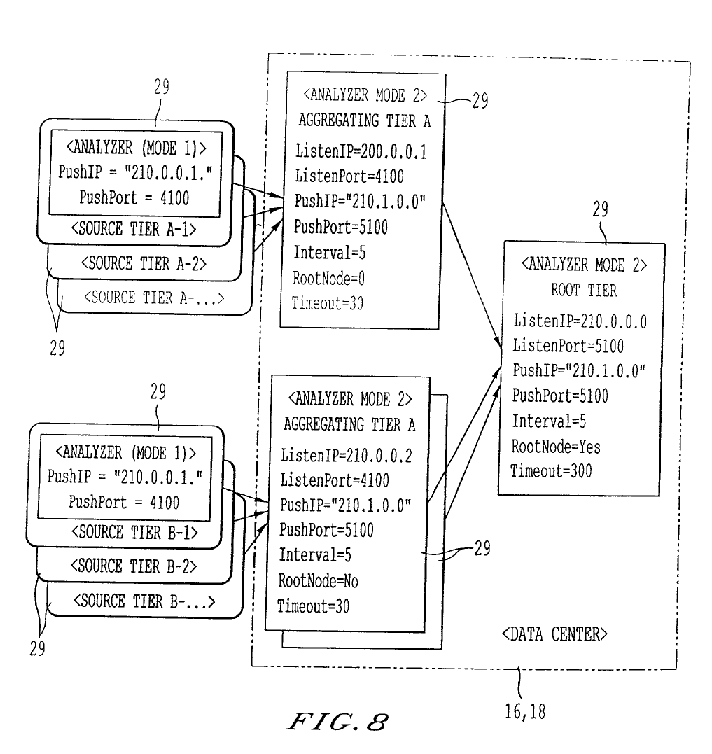

In FIG. 7, there are three different machines running on slightly different time. Even though machines are time-synched, it is generally not possible to have them perfectly time-synched. Machine A is a child who wants to push data whenever the sampling interval elapeses, and Machine B is waiting for the child node's data pushing. But the problem is that these two machines are running on slightly different time.

In this example, the time of machine B is slightly faster than machine A. Thus, when A connects to B (12:05am: described in square callout box), Machine B's time is prior to the sampling time period end. From machine B's point of view, a connecting request prior to the sampling period end is not a valid connection request. But if this request is lost, the final result is not correct. In conclusion, ‘TimeSkew’ variable value is introduced, so that even if connection requests arrive before the sampling period ends, it can be accepted as long as the connection is made within the TimeSkew+Connection (30 sec) period.

FIG. 7 shows that time period connection available is as follows:

SamplingEnd−TimeSkew≦Connection Try≦SamplingEnd+Timeout

→12:04:40≦Connection Try≦12:05:30 (if TimeSkew 32 20 seconds)

The following is a formula to determine ‘TimeSkew’ variable and its example:

0≦TimeSkew≦(Interval×60)×⅓ (Usually interval is set in ‘Minutes’)

→0≦TimeSkew<100

If ‘TimeTransmit’ value is set to any analyzer module in Mode2 (i.e., Mode1 need not be implemented to support this function), it tries to spread data sending for ‘TimeTrasmit’ value. If shortest duration transmit time from Machine B in FIG. 7 is ‘60’ seconds, and that time is extended to ‘240’ seconds, maximal bandwidth can be spread to one-fourth of the original setup. This is illustrates why ‘the TimeTransmit’ value is advantageous. If transmit time takes longer than ‘TimeTransmit’, data pushing is discarded.

If the ‘TimeTransmit’ value of Machine B is set to a larger value than the Timeout value of Machine C (300 sec), Machine B is not able to push data, because whenever B tries to push data, the Timeout time is already elapsed on Machine C. Thus, attention needs to be paid to the setting of this value. The basic formula used by an analyzer moduke to verify ‘timeTransmit’ value is shown below:

0≦TimeTransmit≦(Interval×60)×⅓

→0≦TimeTransmit≦300

The analyzer module 29 uses an XML-based configuration file containing the IP addresses and ports to be used to listen and which pushes data from child to parent and vice versa. The analyzer module setup and deployment methods will now be discussed.

Common settings (i.e., settings used for Mode1 or Mode2) include, but are not limited to: (1) specification of mode, that is, whether the analyzer module 29 is executing in Mode1 or Mode2; (2) Listen IP and Listen Port; (3) PushIP and Push Port; and (4) Interval. Analyzer modules in Mode1 or Mode2 need to specify from which IP address it receives data. For Mode1, the analyzer module 20 uses Listen IP and Listen Port to listen for UDP packets than contain analyzer commands from other programs such as a parser module 41. For Mode2, the analyzer module 20 uses Listen IP and Listen Port to bind a socket where an analyzer module in Mode1 can push data. The PushIP and Push Port pair is the destination to which an analyzer module pushes data. The Interval is the sampling rate used by an analyzer module in Mode1. The hierarchy of analyzer modules, however, need to be aware of this value to calculate the data sample time from a received time tag.

Mode1 settings include, but are not limited to: (1) MulticastIP; and (2) List of Source IP. If an analyzer module 29 executing in Mode1 is set up to accept commands sent via multicast, ‘MulticastIP’ is specified. The analyzer module executing Mode1 uses UDP as a transport protocol. To avoid hacking, a user may specify a list of IP addresses that should be accepted by iAnalyzer. Thus, even if a command is valid, if the origin IP address of the command is not listed here, it is ignored. For example, if ‘127.0.0.1’ is assigned in <List> section, only commands sent from the machine with that IP are accepted, and others are ignored.

Mode2 settings include, but are not limited to: (1) rootnode=[Yes/No]; (2) Timeout=[# in seconds]; (3) timeskew=[# in seconds]; (4) timetransmit=[# in seconds]; (5) processwindow=[# of process running synchronously]; and (6) threadcount=[# of Thread to be launched]. If an analyzer module executing in Mode2 is specified as a Root Node, it pushes data without using the regular push method. The Root Node of the data mining and analysis system 11 uses XBM calls to send entire tables to a specific table processor, which will store these table ‘snapshots’ into the database management system 45.

The timeout’ value should be less than the ‘interval.’ if, for instance, the interval is five minutes, ‘timeout’ should be less than 300 seconds. This prevents data from being missed during transmission from the bottom layer all the way up to the top layer. Although the total number of threads is set to 10, the user might want to slow down data transmission. If ‘ProcessWindow’ is set to 3, only 3 threads out of 10 will start to work. Once one of the first 3 finishes its job, the next thread will start working, until all threads have finished. ProcessWindow is a method of “bandwidth throttling” to spread bandwidth usage. It takes longer, but uses less bandwidth. This value dynamically changes in real-time based on TimTransmit’. if the last transmit finishes earlier than ‘TimeTransmit’, the ProcessWindow decreases and if it takes longer than TimTransmit, the ProcessWindow increases to accelerate processing automatically, but if the ‘TimeTransmit’ value is ‘0’, the ProcessWindow does not change.

The analyzer module 29 launches as many threads as ThreadCount. For a single processor computer, setting it to more than 32 is not recommended. If the computer has dual- or quad-CPU, the user may increase threadcount to 64˜128.

With continued reference to FIG. 5, the first priority of the real-time log reporting system is to report the current connected client count and the peak connected client count for each media server. The parser module 41 uses ‘Total’ and ‘TotalBiggest’ methods for its number field definition to get the current connection count and peak connection count.

TABLE 12
Data Used for Marketing

| CUSTOMER | | |
|---|---|---|
| (ex: CNN, MTV) | # Current Clients | # Peak Clients |
| OnAirReal | 21 | 64 |
| OnStage Real | 34 | 55 |
| OnDemand Real | 30 | 108 |
| OnAir WMT | 400 | 554 |
| OnStage WMT | 311 | 202 |
| OnDemand WMT | 231 | 213 |

As stated above the total number of fields is the number of services multipled by the number of media types.

The parser module 41 configuration has information on how to create tables and fields. The commands required to create the table and record format shown in table 11, for example, are as follows:

<ex: Table name=“Summary”, Customer=“CNN”>

Register summary cnn OnAir-real num total+totbiggest+etotbiggest

Register summary cnn OnStage-real num total+totbiggest+etotbiggest

Register summary cnn OnDemand-real num total+totbiggest+etotbiggest

Register summary cnn OnAir-wmt num total+totbiggest+etotbiggest

Register summary cnn OnStage-wmt num total+totbiggest+etotbiggest

Register summary cnn OnDemand-wwmt num total+totbiggest+etotbiggest

The ‘etotbiggest’ method means that ‘totbiggest’ value must be reset at every interval, back to the ‘total’. ‘Total’ means current number of connected clients. Whenever a new client connects, parser module 41 sends “+1”; when a client disconnects, it sends “−1”. The total value means total count of currently connected clients.

As explained previously, whenever a new customer (e.g. ABC, FOX, etc) appears in the log data, parser module 41 registers the related fields and if there was no table or record to house them, analyzer module 29 automatically creates it. If new data comes in, parser module 41 finds the field to be updated. The commands below show that how those commands would look like.

Setfield summary cnn OnAir-real 1

Setfield summary cnn OnDemand−wmt 1

Setfield summary cnn OnDemand−wmt 1

Setfield summary cnn OnDemand−wmt−1

Setfield summary cnn OnAir−real−1

Setfield summary cnn OnAir−real 1

Setfield summary cnn OnAir−real 1

On executing those command, the value of OnAir-real would be ‘2=1−1+1+1’ and OnDemand-wmt would be ‘2=1+1−1”.

The analyzer module in Mode1 gets commands from parser module 41, adds the table/record/field requested, and if the specified time interval elapses, pushes the data up to the analyzer module 29 Mode2 located in the data center. The aggregating tier is usually set to timeout in 30 seconds; therefore, connections after 30 seconds have elapsed since the last interval ended are ignored. Normally, parser module 41 and analyzer module 29 mode1 are installed on the same machine; they should not be installed on separate machines because the UDP protocol is not reliable. But analyzer module 29 Mode1→Mode2 transfers use TCP, so the installation setup of analyzer module 29s in aggregating tiers are more flexible.

Once the tables are aggregated on the root tier, it connects to the Java app server 43 and sends a snapshot of the tables using XBM. When the root tier sends a snapshot of a table, it uses an XML-based table description format. A sample XML table description is shown below. An XBM call is made as many times as analyzer module 29 has records and tables. Following sample shows 2 XBM calls.

```
# call 1
<analyzer module 29-root version=”1.0” date=”2000-0601” time=”23:00”>
  <Table Name=”Summary” Total=”1” Current=”1”>
  <Record Name=”MTV” Total=”2” Current=”1”>
    <Field Type=”Num” Name=”OnAir-real” Total=”20” TotBiggest=”38”/>
    <Field Type=”Num” Name=”OnStage-real” Total=”42” TotBiggest=”532”/>
    <Field Type=”Num” Name=”OnDemand-real” Total=”12” TotBiggest=”29”/>
    <Field Type=”Num” Name=”OnAir-wmt” Total=”440” TotBiggest=”332”/>
    <Field Type=”Num” Name=”OnStage-wmt” Total=”523” TotBiggest=”231”/>
    <Field Type=”Num” Name=”OnDemand-wmt” Total=”124” TotBiggest=”63”/>
  </Record>
  </Table>
</analyzer module 29-root>
# call 2
<analyzer module 29-root version=”1.0” date=”2000-060 1” time=”23:00”>
  <Table Name=”Summary” Total=”1” Current=”1”>
  <Record Name=”MTV” Total=”2” Current=”1”>
    <Field Type=”Num” Name=”OnAir-real” Total=”67” TotBiggest=”438”/>
    <Field Type=”Num” Name=”OnStage-real” Total=”82” TotBiggest=”322”/>
    <Field Type=”Num” Name=”OnDemand-real” Total=”133” TotBiggest=”29”/>
    <Field Type=”Num” Name=”OnAir-wmt” Total=”240” TotBiggest=”332”/>
    <Field Type=”Num” Name=”OnStage-wmt” Total=”513” TotBiggest=”131”/>
    <Field Type=”Num” Name=”OnDemand-wmt” Total=”24” TotBiggest=”63”/>
  </Record>
  </Table>
</analyzer module 29-root>
```

The root tier can get ‘Time’ and ‘Date’ from ‘TimeTag’ sent from the analyzer module 29 Mode1 instance. This information is used to distinguish a series of table snapshots through time, and field trends by interval/hour/day can be gotten from it. ‘Total’ and ‘Current’ parameters in a <Table> and <Record> tag are serialized in a data push job. As discussed above, if there are two tables and each table has two records, the total number of XBM calls would be four (2×2).

Java app server 43 is software that receives XBM function calls from analyzer module 29, converts them into regular SQL or XML-SQL, and executes them to store data into an Oracle database. Once the data is stored in the database 45, it can be shown to customers in any form. For example, the data can be shown on a secure web site. Regarding the XML-based table description above, it is apparent that the Java app server 43 understands that ‘total’ is the count of current client connections and that ‘totbiggest means peak connection count. After the Java server 43 puts a table snapshot into the database 45 (e.g., an Oracle database), a user application can retrieve it using regular SQL commands.

The data mining and analysis system 11 is advantageous in that, among other reasons, an application can register its own variable when it launches and send information as it registered. If the application needs to change or add a variable format or list, it can simply send an update command to the corresponding analyzer module 29. The analyzer module 29 maintains the analyzed information and servers it to higher level analyzer modules until the root tier analyzer module summarizes the information obtained from all lower level analyzers. The data mining and analysis system 11 of the present invention abstracts mathematical and scaling aspects of different uses to provide essentially real-time reporting and to allow use with a nearly infinitely large network. The trending and dynamic ability to scale the analysis components of the system 11 has many valuable uses such as performing real-time voting. The system 11 can be configured such that the analysis of the voting results is distributed in a manner that requires a central monitoring location to poll only a few remote analyzer modules 29. Accordingly, the system 11 provides a useful way to trend metrics in a network, as well as receive statistical data from on the order of millions of interactive end-users 22.

As stated previously, any network device 21 can be configured to communicate with a local analyzer module 20 and instruct it to start trending or analyzing new information. For voting, an edge node device can register a new variable with its parent analyzer module 29 and indicate that it wants to be analyzed, even though the analyzer modules in the system 11 were not previously configured to collect and analyze voting information. Other nodes that try to register the new variable are ignored; however, they are permitted to send data (e.g., a vote) that affects the requested analysis. In other words, an ‘analysis bean’ can be created and introduced to a system of analyzer modules 29, and other nodes can participate in affecting the analysis of the ‘bean’. The data mining and analysis system 11 of the present invention therefore provides a scalable way to obtain statistical information about a network (e.g., network 12), as well as introduce new metrics without having to reconfigure the analysis software.

Further, by utilizing a multi-tier analyzer deployment, server information can be collated or aggregated at various points in the network, thereby reducing the stress on the network. When a query is generated, it can be answered from information stored in the local database which is populated by the remote analyzers or video server events in a real-time manner. This allows for a statistical query to be answered with very little stress on the network and a specific request to be aggregated using standard queries to the entire network. Thus, all the servers be polled for detailed information only when needed. The stress on the network is directly proportional to the detail of the request for information. In other words, the more detailed the information that is needed, the more information that is requested from the servers. However, if the information is statistical information, this can be gathered from remote statistical software applications that are each responsible for smaller clusters of servers. One example is where a video server sends information about every request it receives. A local analyzer can keep track of the top ten requests. A parent device to that analyzer can then use these top ten requests to create a new top ten between all of its children analyzers. The top analyzer can then generate a list of the top ten requests for the entire network, while the other analyzers keep track of their respective and more localized top ten lists.

Although the present invention has been described with reference to a preferred embodiment thereof, it will be understood that the invention is not limited to the details thereof. Various modifications and substitutions will occur to those of ordinary skill in the art. All such substitutions are intended to be embraced within the scope of the invention as defined in the appended claims.

What is claimed is:

1. A method of performing distributed data mining and analysis comprising the steps of:
arranging a plurality of analyzer modules in a network for collecting information relating to a number of different network devices, each of said analyzer modules being operated in a parent-child relationship with another of said analyzer modules;
sending information relating to said network devices from the corresponding child analyzer modules with which said network devices operate to at least one parent analyzer module;
aggregating said information received from at least one of said child analyzer modules at a first one of said parent analyzer modules; and
transmitting said aggregated information to a second one of said parent analyzer modules with which said first parent analyzer module is a child module.
